(19) United States
(12) Patent Application Publication
(10) Pub. No.: US 2010/0147013 A1
(43) Pub. Date: Jun. 17, 2010

(54) MULTI-CYLINDER ROTARY COMPRESSOR AND REFRIGERATION CYCLE EQUIPMENT

(75) Inventor: Takuya Hirayama, Fuji-Shi (JP)

Correspondence Address: DLA PIPER LLP US, P. O. BOX 2758, RESTON, VA, 20195, US

(73) Assignee: TOSHIBA CARRIER CORPORATION, Tokyo (JP)

(21) Appl. No.: 12/712,780

(22) Filed: Feb. 25, 2010

Related U.S. Application Data
(63) Continuation of application No. PCT/JP08/65461, filed on Aug. 28, 2008.

(30) Foreign Application Priority Data
Aug. 28, 2007 (JP) 2007-221616

(51) Int. Cl. F25D 9/00; F16C 3/18

(52) U.S. Cl. 62/401; 74/595

(57) ABSTRACT

A rotary compressor, in which formulas Rc<Rm+e and RC≧Rs+e are established, when the radius of a main shaft is Rm, the radius of a countershaft is Rs, the radius of a crankshaft is Rc, and the eccentricity is e, a connecting part has a A-periphery which is formed on the counter-eccentric side periphery of the second crankshaft, and a B-periphery formed on the counter-eccentric side periphery of a first crankshaft, and a formula H>L≧H−Cr−Cs is established, when the axial direction of the connecting part is L, the axial length of the first roller is H, the axial length of a bevel formed at the inside edge of the first roller is Cr, and the axial direction of a bevel of the second crankshaft is Cs.

### CROSS-REFERENCE TO RELATED APPLICATIONS

This is a Continuation Application of PCT Application No. PCT/JP2008/065461, filed Aug. 28, 2008, which was published under PCT Article 21(2) in Japanese.

This application is based upon and claims the benefit of priority from prior Japanese Patent Application No. 2007-221616, filed Aug. 28, 2007, the entire contents of which are incorporated herein by reference.

### BACKGROUND OF THE INVENTION

1. Field of the Invention

The present invention relates to a multi-cylinder rotary compressor provided with an improved compression mechanism, and refrigeration cycle equipment using the multi-cylinder rotary compressor for making a refrigeration cycle.

2. Description of the Related Art

Refrigeration cycle equipment comprising a refrigeration circuit uses various types of compressor. For example, an air-conditioner often uses a multi-cylinder rotary compressor, or a two-cylinder compressor. Such a type of compressor has a sealed case housing a motor unit and compressor mechanisms. The motor unit and compression mechanisms are connected through a rotary shaft.

In the above compression mechanism, a rotary shaft comprises a main shaft pivotally fixed to a main bearing, a countershaft pivotally fixed to a sub-bearing, crankshafts which are eccentrically provided between the main shaft and countershaft, fitted with rollers, and a connecting part connecting the crankshafts. The crankshafts and rollers are housed eccentrically rotatable in a cylinder chamber formed inside a cylinder.

In other words, two crankshafts are provided in the main shaft and countershaft. Two cylinders, having cylinder chambers for housing the crankshafts and rollers, are provided. An intermediate partition board is inserted between the cylinders. The connecting part provided between the crankshafts faces the intermediate partition board.

In a multi-cylinder rotary compressor, it is desirable to decrease the diameter of a crankshaft, which is the largest in the sliding part of a rotary shaft, decrease friction loss, and increase efficiency. At the same time, it is recommendable to decrease the height (axial length) of a cylinder, and increase the eccentricity of a crankshaft, in order to decrease sliding loss.

Usually, the main shaft and countershaft forming the above rotary shaft are formed to have the same radius Rm. Assuming the radius of the crankshaft to be Rc and the eccentricity of the crankshaft to be 2, the following formula is established. The diameters of the crankshaft and cylinder chamber can be decreased, and the above advantageous condition can be obtained.

Rc<Rm+e

The problem is the axial length L of the connecting part provided between the crankshafts, and the axial length H (cylinder thickness) of the roller fitted to the crankshaft, which are necessary for fitting the roller to the crankshaft. For example, the axial length L of the connecting part is set smaller than the axial length H of the roller (L<H).

In this case, according to the above relationship (L<H), even if the roller can be inserted from the end face of the countershaft and the connecting part can be connected to the crankshaft provided in the countershaft, when the inserted end face of the roller contacts the end face of the crankshaft provided in the main shaft, the other end face of the roller opposite to the inserted end is positioned oppositely to the crankshaft provided in the countershaft. In other words, the inserted end face of the roller contacts the end face of the crankshaft of the main shaft before the roller does not completely come out of the crankshaft of the countershaft, and the roller cannot be fitted to the crankshaft of the main shaft.

Jpn. Pat. Appln. KOKAI Publication No. 2003-328972 discloses a technique of decreasing the diameter of a countershaft to be smaller than a main shaft, contracting the outer periphery of the side opposite to an eccentric shaft in the crankshaft, from the outer periphery of the main shaft, providing a part having a diameter smaller than the outside diameter of the main shaft in a connecting part (a joint), and making the axial length of the small diameter part greater than the axial length of the roller fitted to the crankshaft of the main shaft.

Jpn. UM Appln. KOKOKU Publication No. 55-48887 discloses a crankshaft comprising a columnar part in which a connecting part formed between adjacent crankshafts (crankpins) is concentric with a rotary shaft line, and smaller than the outside diameter of the crankshaft; and a connecting wall part which is formed on both end faces of the columnar part, and has a cross section which is overlapped when the columnar part and crankshaft are overlapped in the axial direction of the rotary shaft.

### BRIEF SUMMARY OF THE INVENTION

According the technique disclosed in Jpn. Pat. Appln. KOKAI Publication No. 2003-328972, a configuration expressed by the above formula Rc<Rm+e is possible, and it is possible to insert a roller from the end face of a countershaft, pass over a crankshaft provided in the countershaft, and fitted to the crankshaft of the main shaft after once placing in a connecting part. Thereafter, another roller is fitted to the crankshaft of the countershaft. This facilitates the assembling work.

However, in the technique disclosed in Jpn. Pat. Appln. KOKAI Publication No. 2003-328972, it is necessary to provide a part having smaller diameter than the main shaft in the connecting part between the crankshafts of the main shaft and countershaft, and to make the axial length of the part greater than that of the roller fitted to the crankshaft of the main shaft.

Therefore, particularly when the axial length of the roller fitted to the crankshaft of the main shaft is greater, it is necessary to provide a connecting part whose axial length is greater than that of the roller, and the distance between the crankshafts becomes large. This decreases the rigidity of the connecting part, and causes a problem in the reliability and performance.

On the other hand, in the technique described in Jpn. UM Appln. KOKOKU Publication No. 55-48887, the cross-sectional area of the connecting part can be made greater than that in the prior art, and the rigidity is improved. However, in this technique, a large diameter part of a connecting rod is connected to a crankshaft, and the axial length (thickness) of the large diameter part is made less than that of the connecting part.

Therefore, no problem arises when the large diameter part of the connecting rod is connected to the crankshaft. However, as described above, considering the configuration of fitting the roller to the crankshaft, the axial length L of the connecting part is made greater than or equal to (LH) the axial length H of the roller (crankshaft), and a problem arises in the rigidity of the connecting part.

The invention has been performed in the above circumstances. It is an object of the invention to provide a multi-cylinder rotary comprising two or more compression mechanisms, in which a roller to be fitted to a crankshaft of a main shaft is inserted from the direction of the end face of a countershaft, the crankshaft diameter is decreased as much as possible to reduce sliding loss, the axial length of a connecting part, which is the distance between the crankshafts, is reduced, and the compression mechanism is made compact, thereby the compression performance and reliability are improved, and refrigeration cycle equipment which comprises the multi-cylinder rotary compressor for improving refrigeration efficiency and reliability.

In order to satisfy the object, a multi-cylinder rotary compressor of the present invention comprises a rotary shaft which comprises a main shaft pivotally fixed to a main bearing, a countershaft pivotally fixed to a sub-bearing, crankshafts provided eccentrically between the main shaft and countershaft, and fitted with rollers, and a connecting part connecting adjacent crankshafts; and cylinder chambers which house the crankshafts and rollers of the rotary shaft in being eccentrically rotatable, wherein formulas (1) and (2) are established, assuming the radius of the main shaft of the rotary shaft to be Rm, the radius of the countershaft to be Rs, the radius of the crankshaft to be Rc, and the eccentricity of the crankshaft to be e,

Rc<Rm+e (1)

Rc≧Rs+e (2)

the connecting part which connects a first crankshaft provided in the main shaft and a second crankshaft provided in the countershaft, comprises:

an A-periphery, which is positioned on the same level as the outer periphery of the second crankshaft, or inside the outer periphery, on the counter-eccentric side periphery of the second crankshaft 4d, and has a radius greater than the radius Rs of the countershaft; and a B-periphery, which is positioned on the same level as the outer periphery of the first crankshaft, or inside the outer periphery, on the counter-eccentric side periphery of the first crankshaft, and has a radius greater than the radius Rs of the countershaft, and a formula (3) is established, assuming the axial length of the connecting part to be L, the axial length of the roller fitted to the first crankshaft to be H, the axial length of a bevel formed at the inside peripheral edge of the roller fitted to the first crankshaft to be Cr, and the axial length of a bevel formed in the second crankshaft to be Cs,

H>L≧H−Cr−Cs (3)

In order to satisfy the object, refrigeration cycle equipment of the present invention comprises above multi-cylinder rotary compressor, a condenser, an expansion device, and an evaporator.

### BRIEF DESCRIPTION OF THE SEVERAL VIEWS OF THE DRAWING

FIG. 1 is an outline sectional view of a multi-cylinder rotary compressor, and a refrigeration cycle of refrigeration cycle equipment, according to a first embodiment of the invention;

FIG. 2A is a sectional view showing the shapes, dimensions, and configurations of a first roller and a part of a rotary shaft of the multi-cylinder rotary compressor;

FIG. 2B is a sectional view of a part of the rotary shaft of the multi-cylinder rotary compressor taken along line T-T;

FIG. 3 is a graph showing the direction and amount of gas load in the multi-cylinder rotary compressor;

FIG. 4A is an explanatory diagram showing steps from insertion of a first roller of the multi-cylinder rotary compressor from the direction of a countershaft, to fitting the roller to a first crankshaft;

FIG. 4B is an explanatory diagram showing steps from insertion of a first roller of the multi-cylinder rotary compressor from the direction of a countershaft, to fitting the roller to a first crankshaft;

FIG. 4C is an explanatory diagram showing steps from insertion of a first roller of the multi-cylinder rotary compressor from a countershaft, to fitting the roller to a first crankshaft;

FIG. 4D is an explanatory diagram showing steps from insertion of a first roller of the multi-cylinder rotary compressor from a countershaft, to fitting the roller to a first crankshaft;

FIG. 5 is an explanatory diagram showing the shapes and dimensions of a connecting part and a first roller of the multi-cylinder rotary compressor, in the state in which the first roller is being in the connecting part;

FIG. 6 is an outline sectional view of a multi-cylinder rotary compressor, omitted in some parts, according to a second embodiment of the invention;

FIG. 7A is a sectional view showing the shapes, dimensions, and configurations of a first roller and a part of a rotary shaft of the multi-cylinder rotary compressor;

FIG. 7B is a sectional view of a part of the rotary shaft of the multi-cylinder rotary compressor taken along line T-T;

FIG. 8A is an explanatory diagram showing steps from insertion of a first roller of the multi-cylinder rotary compressor from a countershaft, to fitting the roller to a first crankshaft;

FIG. 8B is an explanatory diagram showing steps from insertion of a first roller of the multi-cylinder rotary compressor from a countershaft, to fitting the roller to a first crankshaft;

FIG. 8C is an explanatory diagram showing steps from insertion of a first roller of the multi-cylinder rotary compressor from a countershaft, to fitting the roller to a first crankshaft;

FIG. 8D is an explanatory diagram showing steps from insertion of a first roller of the multi-cylinder rotary compressor from a countershaft, to fitting the roller to a first crankshaft;

FIG. 8E is an explanatory diagram showing steps from insertion of a first roller of the multi-cylinder rotary compressor from a countershaft, to fitting the roller to a first crankshaft;

FIG. 9 is an explanatory diagram showing the shapes and dimensions of a connecting part and a first roller of the multi-cylinder rotary compressor in the state in which the first roller is being in the connecting part;

FIG. 10 is an outline sectional view of a multi-cylinder rotary compressor, omitted in some parts, according to modifications of the first and second embodiments of the invention;

FIG. 11 is an outline sectional view of a multi-cylinder rotary compressor, omitted in some parts, according to a third embodiment of the invention;

FIG. 12A is an explanatory diagram showing the shape and dimensions of a part of a rotary shaft used in a compression mechanism of the multi-cylinder rotary compressor;

FIG. 12B is an explanatory diagram showing the shape and dimensions of a part of a rotary shaft used in a compression mechanism of the multi-cylinder rotary compressor; and

FIG. 13 is an explanatory diagram showing machining of first and second inclined surfaces of a rotary shaft of the multi-cylinder rotary compressor.

### DETAILED DESCRIPTION OF THE INVENTION

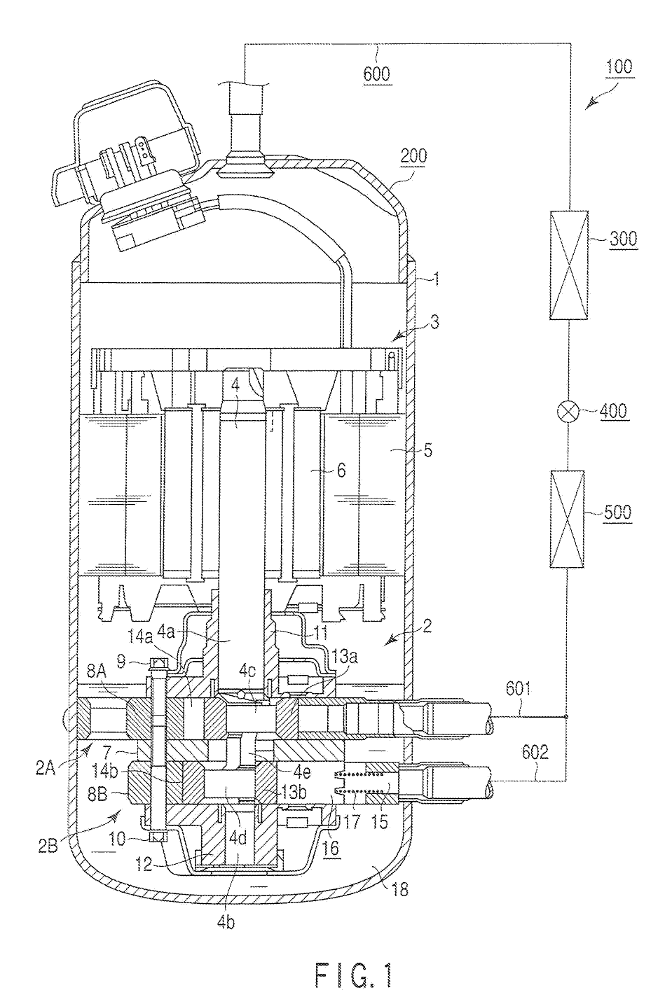

Embodiments of the invention will be explained hereinafter with reference to the accompanying drawings. FIG. 1 shows a sectional view of a structure of a multi-cylinder rotary compressor 200 according to a first embodiment of the invention, and an outline block diagram of refrigeration cycle equipment R comprising the multi-cylinder rotary compressor 200.

First, a configuration of the refrigeration equipment R will be explained. The refrigeration equipment R comprises a multi-cylinder rotary compressor 200, a condenser 300, an expansion device 400, an evaporator 500, and a not-shown gas-liquid separator. These components are sequentially communicated through a refrigerant pipe 600. As described later, refrigerant gas compressed by the multi-cylinder rotary compressor 200 is discharged to the refrigerant pipe 600, circulated through the above components, forming a refrigeration cycle, and fed back to the multi-cylinder rotary compressor 200.

Next, the multi-cylinder rotary compressor 200 will be described in detail.

Reference number 1 in FIG. 1 denotes a sealed case. A compression mechanism 2 is provided in the lower part of the sealed case 1, and a motor unit 3 is provided in the upper part. The compression mechanism 2 and motor unit 3 are connected through a rotary shaft 4.

The motor unit 3 uses a brushless synchronous motor (an AC motor or commercial power motor), for example, and comprises a stator 5 which is press fitted to the interior of the sealed case 1, and a rotor 6 which is provided inside the stator 5 with a predetermined clearance, and fitted to the rotary shaft 4.

The compression mechanism 2 comprises a first compression mechanism 2A, and a second compression mechanism 2B. The first compression mechanism 2A is provided in the upper part of the sealed case, and comprises a first cylinder 8A. The second compression mechanism 2B is formed in the lower part under the first cylinder 8A through an intermediate partition board 7, and comprises a second cylinder 8B.

The first cylinder 8A is press fitted to the inside of the sealed case 1. A main bearing 11 is provided on the upper surface of the first cylinder 8A. The main bearing 11 and valve cover are fixed to the first cylinder 8A by a fixing bolt 9. A sub-bearing 12 and valve cover are stacked on the lower surface of the second cylinder 8B, and fixed to the first cylinder 8A by a fixing bolt 10 through the intermediate partition board 7.

A part pivotally fixed to the main bearing 11 is called a main shaft 4a, and a part pivotally fixed to the sub-bearing 12 that is the lowermost end of the rotary shaft 4 is called a countershaft 4b. A first crankshaft 4c is provided at a position penetrating the inside of the first cylinder 8A of the rotary shaft 4 in one piece with the first cylinder. A second crankshaft 4d is provided at a position penetrating the interior of the second cylinder 8B in one piece with the second cylinder.

In other words, the first crankshaft 4c is provided in the main shaft 4a, and the second crankshaft 4d is provided in the countershaft 4b. A connecting part 4e is inserted between the crankshafts 4c and 4d, and faced to the intermediate partition board 7. The shapes and dimensions of the connecting part 4e and surrounding parts will be described later.

The crankshafts 4c and 4d are formed with a phase difference of about 180°, in being displaced by the same distance from the center axes of the main shaft 4a and countershaft 4b of the rotary shaft 4, having the same diameter. The inside diameter part of the first roller 13a is fitted to the first crankshaft 4c, and the inside diameter part of the second roller 13b is fitted to the second crankshaft 4d. The first and second rollers 13a and 13b are formed to have the same outside diameter.

The inside peripheries of the first and second cylinders 8A and 8b are separated into upper and lower parts by the main bearing 11, intermediate partition board 7, and sub-bearing 12. The first roller 13a and first crankshaft 4c are housed eccentrically rotatable in a first cylinder chamber 14a separated by the above members. The second roller 13b and second crankshaft 4d are housed eccentrically rotatable in a second cylinder chamber 14b separated by the above members.

The first and second rollers 13a and 13b are formed with a phase difference of 180°; but designed to have a part of the A-periphery along the axial direction of the rollers 13a and 13b eccentrically rotatable while making line contact with the peripheral walls of the cylinder chambers 14a and 14b.

Blade chambers are provided in the first and second cylinders 8A and 8B. Each blade chamber contains a blade 16 and a spring member 17 (shown only in one of them). The spring member 17 is a compression spring, which applies elastic force (back pressure) to the blade 16, and makes its front end line contacting along the axial direction of the peripheral surface of the rollers 13a and 13b.

Therefore, the blade 16 reciprocates along the blade chamber 15, and divides the cylinder chambers 14a and 14b into two compartments regardless of the rotation angles of the first and second rollers 13a and 13b.

A discharge valve mechanism is provided in the main bearing 11 and sub-bearing 12. Each discharge valve mechanism communicates with the cylinder chambers 14a and 14b, and is covered with a valve cover. As described later, the discharge valve mechanism is opened when the pressure of the refrigerant gas compressed in the cylinder chambers 14a and 14b is increased to a predetermined value. The compressed refrigerant gas is discharged from the cylinder chambers 14a and 14b into the valve cover through the discharge valve mechanism, and led to the sealed case 1.

A suction hole is provided in the area from the outer periphery to the inside diameter part of the first cylinder 8A, penetrating the sealed case 1. The suction hole is connected to a refrigerant pipe 601 communicating with the evaporator 500 from the gas-liquid separator. Another suction hole is provided in the area from the outer periphery to the inside diameter part of the second cylinder 8B, penetrating the sealed case 1. The suction hole is connected to a refrigerant pipe 602 communicating with the gas-liquid separator from the evaporator 500.

An oil sump 18 to collect lubricant is formed at the inside bottom of the sealed case 1. The entire second compression mechanism 2B and most parts of the first compression mechanism 2A are immersed in lubricant. As the rotary shaft 4 is rotated, an oil pump provided on the end face of the countershaft 4b absorbs and supplies lubricant to the sliding area of the parts constituting the compression mechanism 2.

In the multi-cylinder rotary compressor 200 configured as above, when the motor unit 3 is energized, the rotary shaft 4 is rotated, the first roller 13a is eccentrically moved in the first cylinder chamber 14a, and the second roller 13b is eccentrically moved in the second cylinder chamber 14b. The refrigerant gas separated by the gas-liquid separator is drawn into one of the chambers separated by the blade 16 in each cylinder chamber 14a and 14b and provided with a suction hole, through the suction refrigerant pipes 601 and 602 of the suction side.

As the first and second crankshafts 4c and 4d fixed to the rotary shaft 4 are formed to have a phase difference of 180°, the same phase difference 180° occurs at the time of drawing the refrigerant gas into the cylinder chambers 14a and 14b. When the first and second rollers 13a and 13b are eccentrically moved, the capacity of the chamber close to the discharge valve mechanism is decreased, and the pressure is increased by the amount equivalent to the decreased capacity.

When the capacity of the chamber close to the discharge valve mechanism reaches a predetermined value, the refrigerant gas compressed in this chamber is increased to a predetermined pressure. At the same time, the discharge valve mechanism is opened, and the compressed high-temperature high-pressure refrigerant gas is discharged into the valve cover. A phase difference of 180° occurs at the time of discharging the compressed refrigerant gas to the discharge valve mechanism.

The compressed refrigerant gas is directly or indirectly led to the space between the compression mechanism 2 and motor unit 3 in the sealed case 1. The compressed refrigerant gas is flowed through the clearances between the rotary shaft 4 and rotor 6 forming the motor unit 3, between the rotor and stator 5, and between the stator 5 and the inner peripheral wall of the sealed case 1, and is filled in the space in the sealed case 1 formed above the motor unit 3.

The compressed refrigerant gas is sent from the multi-cylinder rotary compressor 200 to the refrigerant pipe 600, led to the condenser 300 and condensed, and led to the expansion device 400 and adiabatically expanded, and led to the evaporator and evaporated, releasing latent heat from the surrounding area, and producing the refrigeration effect. The evaporated refrigerant is led to the gas-liquid separator and separated into gas and liquid, and only the gas component is drawn into the compression mechanism 2 of the multi-cylinder rotary compressor 200, and compressed again.

Next, a detailed explanation will be given of the shapes and dimensions of the connecting part 4e constituting the rotary shaft 4, and the surrounding parts.

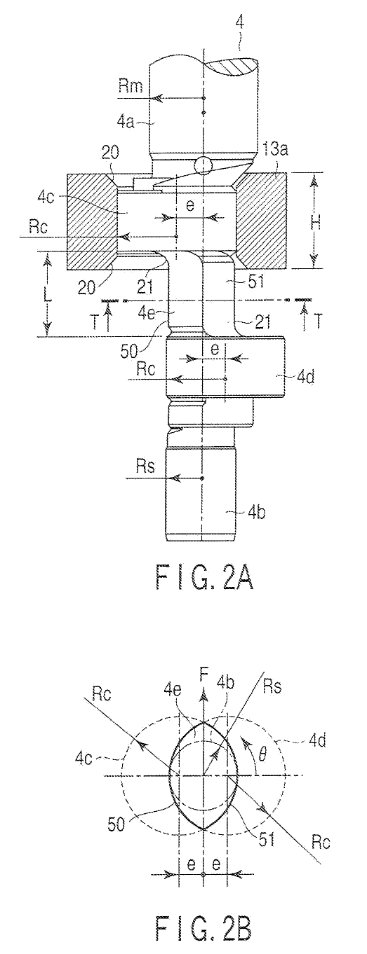

FIG. 2A shows a part of the rotary shaft 4 close to the compression mechanism 2, and the configuration of the first roller 13a. FIG. 2B is a sectional view taken along line T-T of FIG. 2A.

If the compressor is configured to have the following equation (1), assuming that the radius of the main shaft 4a constituting the rotary shaft 4 is Rm, the radius of the countershaft 4b is Rs, the radius of each first and second crankshaft 4c and 4d is Rc, and the eccentricity of each crankshaft 4c and 4d is e,

Rc<Rm+e (1)

the diameters of the first and second crankshafts 4c and 4d, and the first and second cylinder chambers 14a and 14b are reduced, and friction loss can be decreased, and compression efficiency can be improved.

If the compressor is configured to have the following equation (2),

Rc≧Rs+e (2)

the first roller 13a can be inserted from the end face of the countershaft 4b, and passed through the second crankshaft 4d. Therefore, finally, the first roller can be fitted to the first crankshaft 4c.

In the state shown in the drawing, it is confirmed that the center axis line of the first crankshaft 4c is displaced to the left side from the center axis lines of the main shaft 4a and countershaft 4b, and the center axis line of the second crankshaft 4d is displaced to the right side from the center axis lines of the main shaft 4a and countershaft 4b. The following configuration is based on the above confirmation.

The connecting part 4e connecting the first crankshaft 4c and second crankshaft 4d are particularly formed to have a cross section indicated by a solid line in FIG. 2 (hatching is omitted to simplify the drawing).

In other words, in FIG. 2B, when the vertical center axis line and the horizontal center axis line intersecting the vertical center axis line are drawn, an intersection point of the vertical and horizontal center lines coincides with the center axis line of the main shaft 4a and countershaft 4b. The cross section of the connecting part 4e is arc-shaped and bilaterally symmetrical along the vertical center line.

Further, in the cross-sectional shape of the connecting part 4e, the left side arc-shaped part along the vertical center line is a periphery of the counter-eccentric side of the second crankshaft 4d, which is hereinafter called an A-periphery 50. The right side arc-shaped part is a periphery of the counter-eccentric side of the first crankshaft 4c, which is hereinafter called a B-periphery 51.

The above A-periphery 50 is formed on the same level as the outer periphery of the second crankshaft 4d, or inside the outer periphery, and is arc-shaped with a radius greater than the radius Rs of the countershaft 4b.

The above B-periphery 51 is formed at the same level as the outer periphery of the first crankshaft 4c, or inside the outer periphery, and is arc-shaped with a radius greater than the radius Rs of the countershaft 4b.

Therefore, the cross section of the connecting part 4e is shaped to be thickest along the vertical center axis line. For example, assuming the horizontal center axis line θ to be 0°, the thickness is maximum at the position of θ=90°.

The connecting part 4e is formed to have the above cross section. Assuming the axial length of the connecting part 4e to be I, and the length of the first roller 13a fitted to the first crankshaft 4c provided in the main shaft 4a to be H, the axial length H of the first roller 13a is set to be greater than the axial length L of the connecting part 4e (H>L). A bevel 20 cut by predetermined amount is formed at both inside edges of the first roller 13a.

When refrigerant gas is compressed in the multi-cylinder rotary compressor 200 adopting the rotary shaft 4 satisfying the above conditions, gas load is applied to the rotary shat 4 as described below.

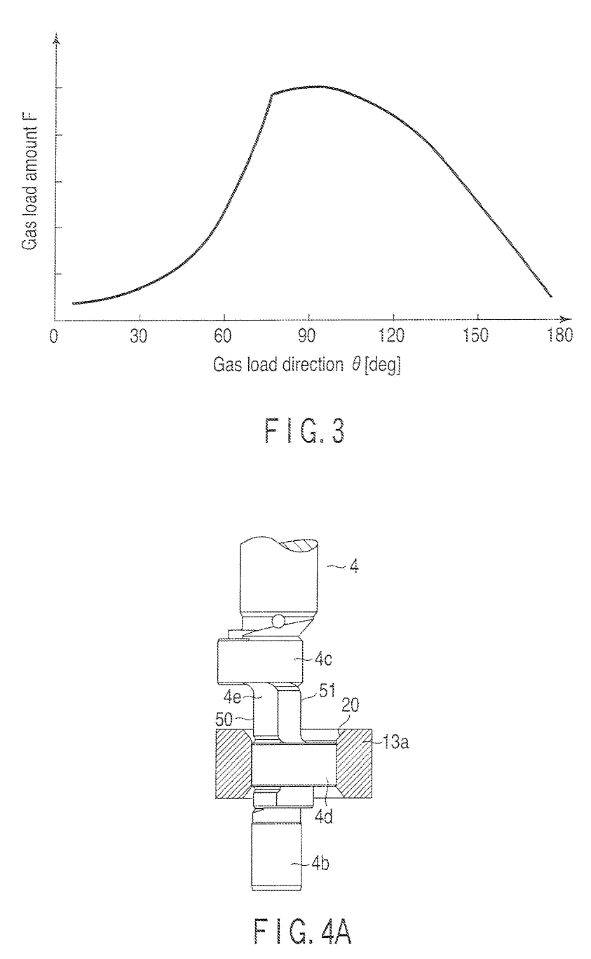

FIG. 3 is a graph showing the relationship between the direction θ [deg] and amount F of gas load applied to the first crankshaft 4c in the multi-cylinder rotary compressor.

As seen from the graph, if the direction of gas load applied to the first crankshaft 4c is expressed on the basis of θ shown in FIG. 2B, the amount of gas load F is maximum when 0 is about 90°. As described above, the connecting part 4e is thickest in the part where θ=90° along the vertical center axis line, and the rigidity is increased, and the connecting part 4e is prevented from being deformed by the gas load.

Jpn. UM Appln. KOKOKU Publication No. 55-48887 describes that sufficient rigidity is not obtained in a connecting part formed between crankshafts, which is formed by connecting the outer peripheral arcs of counter-eccentric sides. This is true for a reciprocating type compressor, in which a maximum load is likely to be applied to the thinnest portion of a connecting part. In contrast, in a rotary compressor according to the present invention, a direction of maximum load coincides with a thickest portion of the connecting part 4e, and the configuration of the connecting part is effective.

The axial length H of the first roller 13a is set to be greater than the axial length L of the connecting part 4e (H>L). In other words, the axial length L of the connecting part 4e is reduced, and the rigidity of the connecting part 4e is increased furthermore.

On the other hand, when the first roller 13a is fitted to the crankshaft 4c, the axial length H of the first roller 13a is greater than the axial length L of the connecting part 4e when the first roller 13a is inserted onto the connecting part 4e from the direction of the counter shaft 4b, and it is difficult to move the first roller 13a from the connecting part 4e to the first crankshaft 4c in this state.

However, as described above, the first roller 13a has the bevel 20 at both inside edges, and the first roller can be easily fit to the first crankshaft 4c by changing the insertion direction when the end face of the insertion side reaches the first crankshaft 4c. In other words, the first roller 13a can be easily and stably fitted to the first crankshaft 4c.

Further, as shown in FIG. 2A, as a raised portion (R-portion) 21 is formed at the corners of the first crankshaft 4c on the A-periphery and second crankshaft 4d on the B-periphery, the rigidity of the base part of the connecting part 4e can be increased without damaging the function and effect described above, and the rigidity of the connecting part 4e can be kept high.

Hereinafter, the work of fitting the first roller 13a to the crankshaft 4c will be explained in detail.

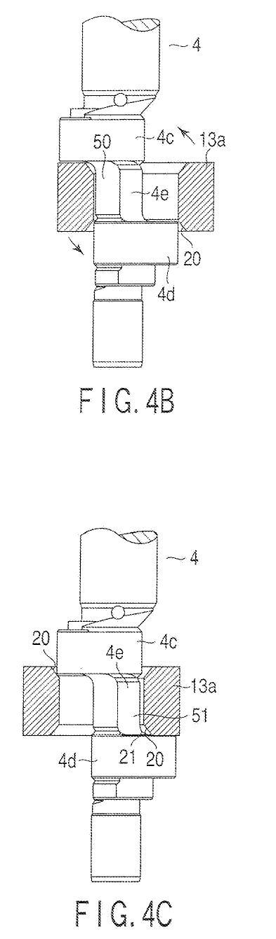

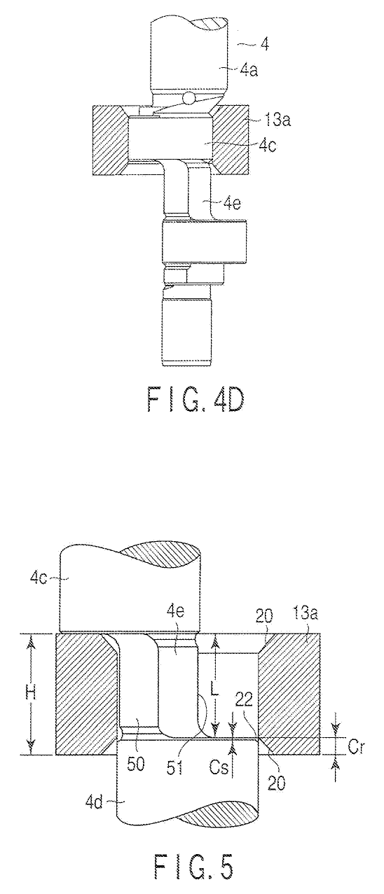

FIGS. 4A to 4D are diagrams explaining the work of fitting the first roller 13a to the first crankshaft 4c.

In FIG. 4A, the first roller 13a inserted from the end face of the countershaft 4b is moved and fitted to the second crankshaft 4d. As the bevel 20 is formed at both inside edges of the first roller 13a, the first roller 13a can be smoothly fitted to the second crankshaft 4d. Therefore, the first roller 13a can be moved up furthermore, and reaches the connecting part 4e.

In FIG. 4B, the first roller 13a is moved to the connecting part 4e. The A-periphery 50 of the connecting part 4e is positioned on the same level as the outer periphery of the second crankshaft 4d, or inside the outer periphery. Therefore, the first roller 13a can be easily smoothly moved from the second crankshaft 4d to the connecting part 42, so that the inside diameter part of the first roller 13a is faced to the A-periphery 50 of the connecting part 4e.

In this state, the end face of the insertion side (upper end face) of the first roller 13a contacts the lower end face of the first crankshaft 4c. Further, as the axial length H of the first roller is set to be greater than the axial length of the connecting part 4e, the lower end face of the first roller 13a is positioned under the lower end of the connecting part 4e.

In this state, it is difficult to move the first roller 13a so that the inside diameter part is faced to the first crankshaft 4c. However, as indicated by an arrow, the first roller 13a is inclined in the counterclockwise direction, and moved in parallel to the left side in the drawing. The bevels 20 formed at both inside edges of the first roller 13a contact, and ride over the edges of the second crankshaft 4d.

The first roller 13a is moved and energized, and the lower end face of the first roller is placed on the upper end face of the second crankshaft 4d. A part of the inside diameter part of the first roller 13a is smoothly inserted into a part of the lower end of the first crankshaft 4c.

As shown in FIG. 4C, the inside diameter part of the first roller 13a faces, contacts, or comes close to the first crankshaft 4c. The lower end face of the first roller 13a is placed on the upper end face of the second crankshaft 4d, and the inside diameter part of the first roller contacts, or come close to the B-periphery 51 of the connecting part 4e. The raised portion 21 formed at the lower end of the B-periphery 51 of the connecting part 4e is placed under the bevel 20 at the lower inside edge of the first roller 13a, and the first roller 13a is correctly faced to the first crankshaft 4c.

As shown in FIG. 4D, if the first roller 13 is moved immediately upward, the inside diameter part of the first roller 13a is fitted to the first crankshaft 4c.

As the axial length H of the first roller 13a is made greater than the axial length L of the connecting part 4e (H>L), the connecting part 4e is reduced in length and increased in rigidity. As the bevel 20 is formed in the connecting part 4e, the first roller is easily fitted to the first crankshaft 4c from the direction of the countershaft 4b through the connecting part 4e.

In FIG. 5, the first roller 13a is moved to the connecting part 4e. Here, the above configuration is adopted, the bevel 22 is formed along the upper peripheral edge of the second crankshaft 4d.

Assuming the axial length of the connecting part 4e to be L, the axial length of the first roller 13a fitted to the first crankshaft 4c provided in the main shaft 4a to be H, the axial length of the bevel 20 formed at the inside peripheral edge of the first roller 13a to be Cr, and the axial length of a bevel 22 formed at the upper peripheral edge of the second crankshaft 4d to be Cs, the relationship of H>L is as described above.

L+Cs≧H−Cr

L≧H−Cr−Cs

H>L≧H−Cr−Cs (3)

Further, the connecting part is configured to meet the above formula (3).

As described above, though the axial length L of the connecting part 4e is made less than the axial length H of the first roller 13a, a bevel 20 is formed in the first roller 13a, and a bevel 22 is formed in the second crankshaft 4d. This facilitates the work of fitting the first roller 13a to the first crankshaft 4c through the countershaft 4b and second crankshaft 4d.

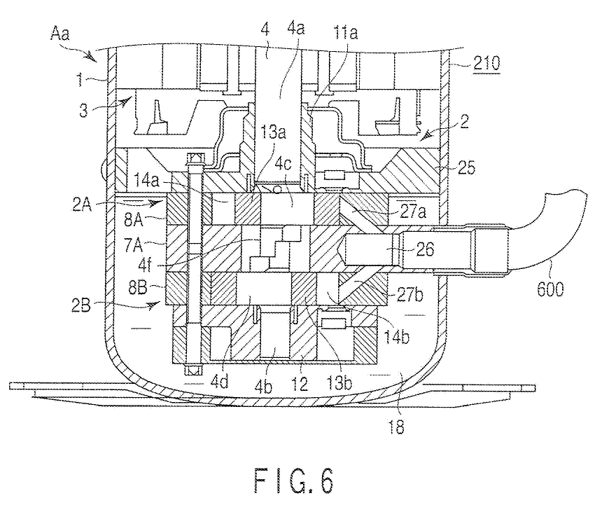

FIG. 6 is a sectional view of a part of a multi-cylinder rotary compressor 210 according to a second embodiment.

In the compressor 210, as in the first embodiment, first and second compression mechanisms 2A and 2B are connected together with a motor unit 3 through a rotary shaft 4, and housed in a sealed case 1. The configuration of the motor unit 3 is the same as that in the first embodiment. The first and second compression mechanisms 2A and 2B are basically the same as those in the first embodiment. Main components are denoted by the same reference numbers, and an explanation thereof is omitted.

In the compression mechanism 2, a main bearing 11a is formed in one piece with a frame 25 press fitted to the sealed case 1, and a first cylinder 8A is fixed to the lower surface of the frame 26. An intermediate partition board 7A is made thick. A suction hole 26 is formed penetrating a part of the sealed case 1 and the outer periphery of the intermediate partition board 7A.

The suction hole 26 is connected to a refrigerant pipe 600 of the suction side through an evaporator 500 and a gas-liquid separator. In the first embodiment, two refrigerant pipes 601, Pb are connected. However, in the second embodiment, only one refrigerant pipe 600 is connected.

The suction hole 26 is formed in the area from the outer periphery of the intermediate partition board 7A to the mid portion before the inside diameter part. Suction guide holes 27a and 27b are formed obliquely upward and downward from the end.

The suction guide hole 27a is provided obliquely upward from the lower surface of the first cylinder 8A, and opened to a first cylinder chamber 14a that is the inside diameter part of the cylinder. The suction guide hole 27b is extended obliquely downward from the upper surface of the second cylinder 8B, and opened to a second cylinder chamber 14b that is the inside diameter part of the cylinder.

Therefore, refrigerant gas is led to the suction hole 26 formed in the intermediate separation plate 7A through one refrigerant pipe 600, divided into two suction guide holes 27a and 27b, and drawn into the first and second cylinder chambers 14a and 14b.

In the multi-cylinder rotary compressor 210 configured as above, the intermediate partition board 7A is thicker than the intermediate partition board 7 in the first embodiment, but the thickness of the first and second cylinders 8A and 8B are basically unchanged.

In other words, the axial lengths of the first crankshaft 4c and first roller 13a housed in the first cylinder chamber 14a, and the axial lengths of the second crankshaft 4d and second roller 13b housed in the second cylinder chamber 14b, are unchanged, but the axial length of the connecting part 4f facing the intermediate partition board 7A and connecting the first and second crankshafts 4c and 4d is greater than that of the connecting part 4e in the first embodiment.

Further, as the gas load applied to the connecting part 4f is unchanged, the rigidity of the connecting part 4f is not ensured in this configuration. Therefore, a configuration described hereinafter is adopted to improve the rigidity of the connecting part 4f, prevent deformation, and improve the reliability.

The shapes and dimensions of connecting part 4f constituting the rotary shaft 4 and peripheral parts will be described in detail hereinafter.

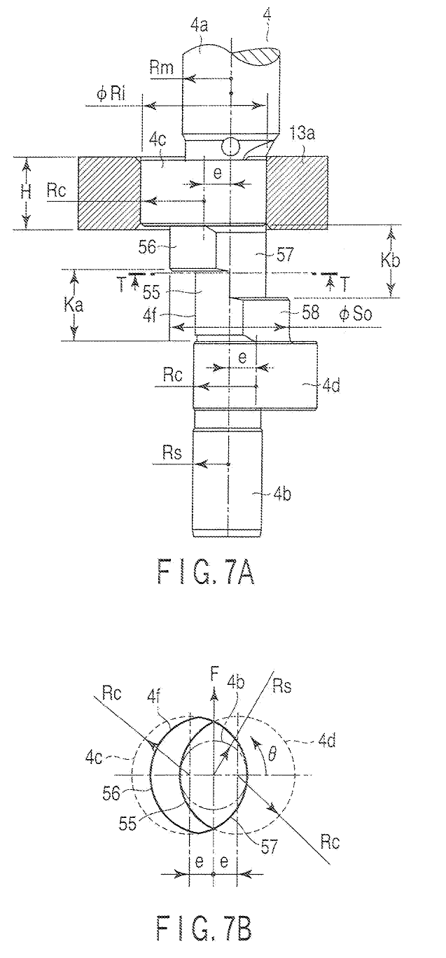

FIG. 7A is a diagram explaining the configuration of a part of the rotary shaft 4 of the compression mechanism 2, and the first roller 13a. FIG. 7B is a sectional view taken along line T-T in FIG. 7A.

Assuming the radius of the main shaft 4a constituting the rotary shaft 4 to be Rm, the radius of the countershaft 4b to be Rs, the radii of the first and second crankshafts 4c and 4d to be Rc, and the eccentricity of the crankshafts 4c and 4d to be e, the rotary shaft 4 is configured to have the formula (4).

Rc<Rm+e (4)

The diameters of the first and second crankshafts 4c and 4d, and the diameters of the first and second cylinder chambers 14a and 14b, are reduced. As a result, friction loss is decreased, and compression efficiency is increased.

If the rotary shaft is configured to have the formula (5), the first roller 13a can be inserted from the end face of the countershaft 4b, and passed through the second crankshaft 4d. Finally, the first roller can be finally fitted to the first crankshaft 4c.

Rc≧Rs+e (5)

The connecting part 4f connecting the first and second crankshafts 4c and 4d is shaped to have a cross section as indicted by a solid line in FIG. 7B (hatching is omitted).

In other words, the counter-eccentric side periphery of the second crankshaft 4d in the connecting part 4f has a A0-periphery 55, which is positioned on the same level as the outer periphery of the second crankshaft 4d, or inside the outer periphery, and has a radius greater than the radius Rs of the countershaft 4b, and a A1-periphery 56, which is formed between the A0-periphery 55 and the first crankshaft 4c, and positioned outside the counter-eccentric side periphery of the second crankshaft 4d.

The counter-eccentric side of the first crankshaft 4c in the connecting part 4f has a B0-periphery 57, which is positioned on the same level as the outer periphery of the first crankshaft 4c, or inside the outer periphery, and has a radius greater than the radius Rs of the countershaft 4b, and a B1-periphery 58, which is formed between the B0-periphery 57 and the second crankshaft 4d, and positioned outside the counter-eccentric side periphery of the first crankshaft 4c.

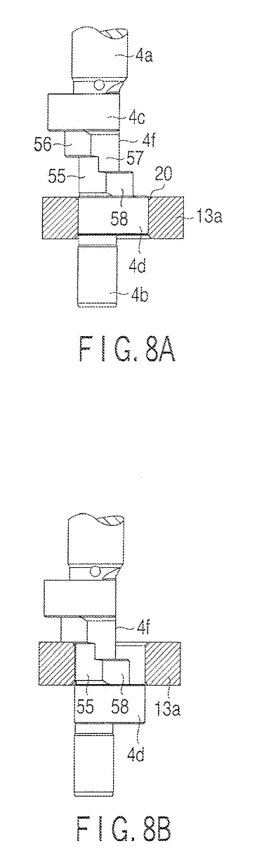

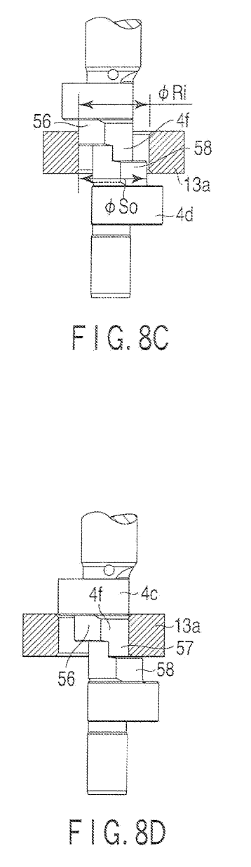

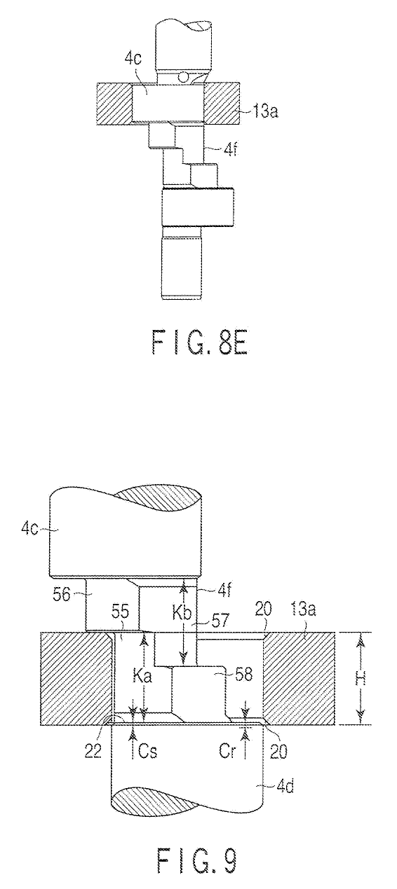

As described later (FIG. 8), the outermost diameter So of the peripheral, surfaces A1 56 and B1 58 is made smaller than the inside diameter Ri of the first roller 13a fitted to the first crankshaft 4c. Further, the axial intermediate part of the connecting part 4f is formed by the A0-periphery 55 and B0-periphery 57.

As the connecting part 4f is formed to have the above cross-sectional shape, the first roller 13a can be easily fitted to the first crankshaft 4c provided in the main shaft 4a, in the specifications adopting the formula (4), Rc<Rm+e, to improve the performance. The axial length of the connecting part 4f is made great, but the A1 and B1 peripheries 56 and 58 are provided to keep the rigidity of the connecting part 4f high, and prevent deformation.

In other words, the gas load F is maximum when θ is about 90° as already explained, but the connecting part 4f has a cross section thickest in the direction of θ=90° along the vertical center axis line, and the connecting part 4f is high in rigidity, and prevented from deformation by gas load.

Further, as the connection part 4f has A1 and B1 peripheries 56 and 58, the axial length of the part comprising the A1 and B1 peripheries 56 and 58, where the rigidity is the lowest, can be reduced, and deformation of the connecting part 4f caused by gas load is prevented.

Next, a detailed explanation will be give of the work of fitting the first roller 13a to the crankshaft 4c in this embodiment.

FIGS. 8A to 8E explain the work of fitting the first roller 13a to the first crankshaft 4c.

In FIG. 8A, the first roller 13a inserted from the end face of the countershaft 4b is moved and fitted to the second crankshaft 4d. As the bevel 20 is formed at the inside peripheral edge of the first roller 13a, the first roller can be smoothly fitted to the second crankshaft 4d. In this state, the first roller 13a is moved up and faced to the connecting part 4e.

In FIG. 8, the first roller is moved to the connecting part 4f. The A0-periphery 55 of the connecting part 4f is positioned on the same level as the outer periphery of the second crankshaft 4d, or inside the outer periphery, and the first roller can be easily moved from the second crankshaft 4d to the connecting part 4f.

Further, the first roller 13a is horizontally moved to the left in the drawing, so that the inside diameter part contacts the B1-periphery 58 of the connecting part 4f, and then moved upward.

As shown in FIG. 8C, the inside diameter part of the first roller 13a is inserted into both peripheral surfaces A156 and B158. As already explained, the outermost diameter So of the A1 and B1 peripheries 56 and B1 58 is smaller than the inside diameter Ri of the first roller 13a, the inside diameter part of the first roller 13a can be smoothly moved up with respect to both peripheries 56 and 58.

When the upper end face of the first roller 13a contacts the lower end face of the first crankshaft 4c, the first roller 13a is moved to the left in the drawing, and placed and slid on the upper end face of the B1-periphery 58. Then, as shown in FIG. 8D, the inside diameter part of the first roller 13a contacts the B0-periphery 57, and separates from the A1-periphery 56. In this state, the inside diameter part of the first roller 13a is correctly faced to the first crankshaft 4c. Then, the first roller 13a is moved immediately upward, and as shown in FIG. 8E, the inside diameter part of the first roller 3a is consequently fitted to the first crankshaft 4c.

As described above, in the connecting part 4f that is long in the axial direction, the A1-periphery 56 is formed between the A0-periphery 55 and first crankshaft 4c, and the B1-periphery 58 is formed between the B0-periphery 57 and second crankshaft 4d. Therefore, the rigidity of the connecting part 4f is increased, and the first roller 13a can be smoothly fitted to the first crankshaft 4c from the direction of the countershaft 4b through the connecting part 4f.

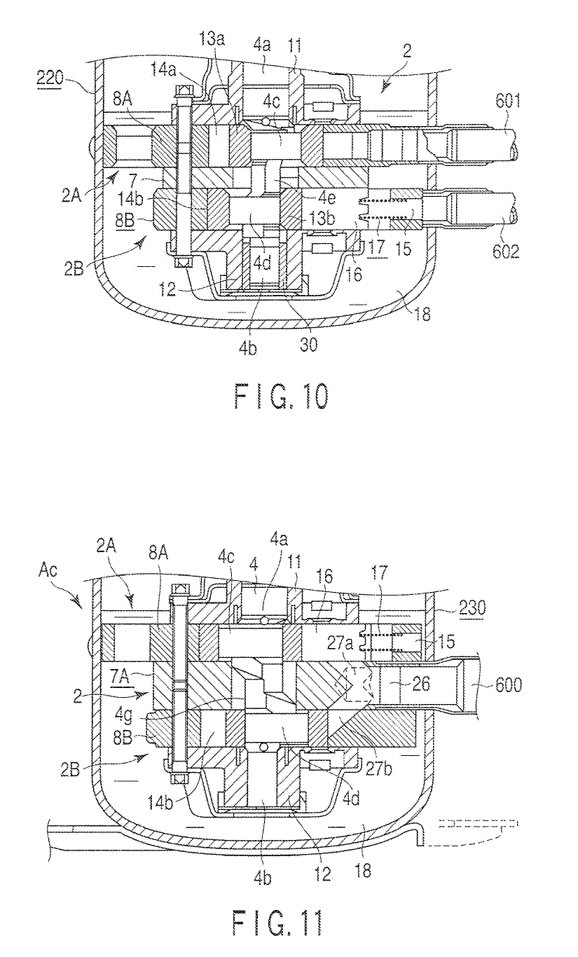

FIG. 9 shows the first roller 13a moved to the connecting part 4f. Here, the above configuration is adopted, and a bevel 22 is formed along the upper end face peripheral edge of the second crankshaft 4d.

Assuming the axial direction of the A0-periphery 55 to be Ka, the axial direction of the B0-periphery 57 to be Kb, the axial direction of the first roller 13a fitted to the first crankshaft 4c to be H, the axial direction of the bevel 20 formed at the inside peripheral edge of the first roller 13a to be Cr, and the axial length of the bevel 22 formed in the second crankshaft 4d to be Cs, the formulas (6) and (7) are established.

H>Ka≧H−Cr−Cs (6)

H>Kb≧H−Cr−Cs (7)

As described above, though the axial length of the connecting part 4f is very large compared with that in the first embodiment, the bevel 20 is formed in the first roller 13a, and the bevel 22 is formed in the second crankshaft 4d. This further facilitates fitting of the first roller 13a to the first crankshaft 4c from the direction of the end face of the countershaft 4b through the second crankshaft 4d.

The A-periphery 50 forming the connecting part 4e in the first embodiment and the A0-periphery 55 forming the connecting part 4f in the second embodiment, consist of a peripheral surface substantially coinciding with the center of the second crankshaft 4d. The B-periphery 51 forming the connecting part 4e in the first embodiment and the B0-periphery 57 forming the connecting part 4f in the second embodiment consist of a peripheral surface substantially coinciding with the center of the first crankshaft 4c.

Therefore, the arc shapes of the peripheral surfaces forming the connecting parts 4e and 4f can be machined coaxially with the first and second crankshafts 4c and 4d, and the manufacturability is improved.

The A1 and B1 peripheries 56 and 58 forming the connecting part 4f in the second embodiment consist of a peripheral surface substantially coinciding with the center of the rotary shaft 4. In other words,

These peripheries can be machined coaxially with the main shaft 4a and countershaft 4b, and the manufacturability is improved.

FIG. 10 is a longitudinal sectional view of a multi-cylinder rotary compressor 220, omitted in some parts, as an example of a modification of the first and second embodiments.

In the drawing, except for a bush 30, the component parts are the same as those of the multi-cylinder compressor 200 explained in the first embodiment (FIG. 1). The same parts are denoted by the same number, and an explanation thereof is omitted. This rotary compressor is applicable as a modification of a not-shown multi-cylinder rotary compressor 210 explained in the second embodiment.

As the first roller 13a is inserted from the end face of the countershaft 4b, and fitted to the first crankshaft 4c through the second crankshaft 4d and connecting parts 4e and 4f, the radius of the countershaft 4b is set to Rs. Comparing with the main shaft 4a, the diameter of the countershaft 4b is small, the sliding radius for the countershaft 12 is small, and the reliability is not ensured.

In the multi-cylinder rotary compressor 220, the radius Rs of the countershaft 4b is unchanged, and the diameter of a pivot hole of a sub-bearing 12 pivotally fixing the countershaft 4b is enlarged by machining. The bush 30 is inserted into the clearance between the peripheral surface of the countershaft 4b and the peripheral surface of the enlarged pivot hole. Actually, the bush 30 is press fitted to the peripheral surface of the countershaft 4b in one piece, and the bush 30 is pivotally fixed to the sub-bearing 12.

For the convenience of fitting the first roller 13a from the direction of the countershaft 4b, even in the specifications in which the diameter of the countershaft 4b is reduced, the sliding radius in the sub-bearing 12 can be increased by using the bush 30, and the reliability is improved.

FIG. 11 is a longitudinal sectional view of a multi-cylinder rotary compressor 230, omitted in some parts, according to a third embodiment.

Except for a connecting part 4g described later, the component parts are the same as those of the multi-cylinder compressor 210 explained in the second embodiment (FIG. 6). The same parts are denoted by the same number, and an explanation thereof is omitted. In the compressor 210, the blade chamber 15, blade 16, and spring member 17 are not shown in the drawing. In the compressor 230, these parts are shown in being fitted to the first cylinder 8A.

As in the multi-cylinder rotary compressor 210 in the second embodiment, comparing with the intermediate partition board 7 of the multi-cylinder rotary compressor 200 in the first embodiment, the thickness of the intermediate partition board 7A is increased, and the axial length of the connecting part 4g of the rotary shaft 4 provided oppositely to the intermediate partition board 7A is increased by the extent equivalent to the increased thickness of the intermediate partition board. Therefore, the rigidity of the connecting part 4g must be ensured for the gas load.

In the multi-cylinder rotary compressor 230 of this embodiment, the rigidity of the connecting part 4g is ensured as described below.

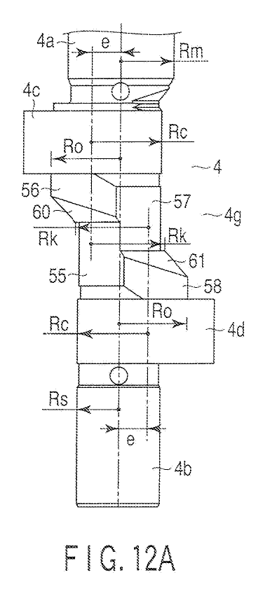

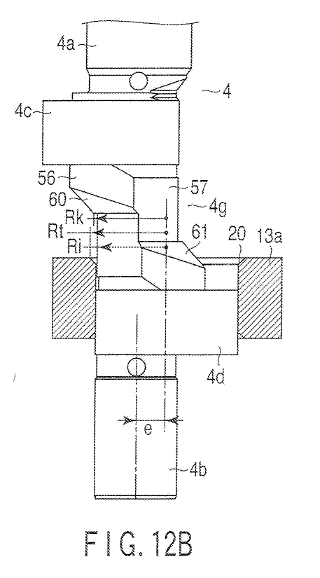

FIG. 12A explains a part of the configuration of the rotary shaft 4 of the compression mechanism 2. FIG. 12B explains the configuration of the first roller 13 and connecting part 4g.

Assuming the radius of the main shaft 4a constituting the rotary shaft 4 to be Rm, the radius of the countershaft 4b to be Rs, the radii of the first and second crankshafts 4c and 4d to be Rc, and the eccentricity of the crankshafts 4c and 4d to be e, the formula (8) is established.

Rc<Rm+e (8)

The diameters of the first and second crankshafts 4c and 4d, and the diameters of the first and second cylinder chambers 14a and 14b, are reduced. As a result, friction loss is decreased, and compression efficiency is increased.

If the formula (9) is established, the first roller 13a can be inserted from the end face of the countershaft 4b, and passed through the second crankshaft 4d. Therefore, the first roller is finally fitted to the first crankshaft 4c.

Rc≧Rs+e (9)

In the connecting part 4g connecting the first and second crankshafts 4c and 4d, the counter-eccentric side periphery of the second crankshaft 4d has an A0-periphery 55, which is positioned on the same level as the outer periphery of the second crankshaft 4d, or inside the outer periphery, and has a radius greater than the radius Rs of the countershaft 4b, and an A1-periphery 56, which is formed between the A0-periphery 55 and the first crankshaft 4c, and positioned outside the counter-eccentric side periphery of the second crankshaft 4d.

Further, the part connecting the A0 and A1 peripheries 55 and 56 has a step caused by the different radii. The step is machined as described later, and a part of conical shape and a first inclined surface 60 having the same shape are formed.

In the connecting part 4g, the counter-eccentric side periphery of the first crankshaft 4c has a B0-periphery 57, which is positioned on the same level as the outer periphery of the first crankshaft 4c, or inside the outer periphery, and has a radius greater than the radius Rs of the countershaft 4b, and a B1-periphery 58, which is formed between the B0-periphery 57 and the second crankshaft 4d, and positioned outside the counter-eccentric side periphery of the first crankshaft 4c.

Further, the part connecting the B0 and B1 peripheries 57 and 58 has a step caused by the different radii. The step is machined as described later, and a part of conical shape and a second inclined surface 61 having the same shape are formed.

As described above, in the connecting part 4g, the counter-eccentric side periphery of the second crankshaft 4d has the A0-periphery 55, A1-periphery 56, and first inclined surface 60. The counter-eccentric side periphery of the first crankshaft 4c has the B0-periphery 57, B1-periphery 58, and second inclined surface 61.

As the connecting part 4g is configured as above, the first roller 13a can be easily fitted to the first crankshaft 4c provided in the main shaft 4a, in the specifications adopting the formula (8) Rc<Rm+e to improve the performance.

The axial length of the connecting part 4g is set to be greater than the connecting part 4e of the multi-cylinder rotary compressor explained in the first embodiment, but the A1-periphery 56 and first inclined surface 60 are provided on the A0-periphery, and the B1-periphery 58 and second inclined surface 61 are provided on the B0-periphery 57.

Therefore, in the connecting part 4g, the step in the eccentric direction can be largely beveled without decreasing the thickness in the eccentric and rectangular directions, and the first roller 13a can be smoothly inserted from one direction of the rotary shaft 4 while maintaining the rigidity. Therefore, it is possible to provide a rigid and versatile rotary shaft 4.

The center position of the A0-periphery 55 substantially coincides with the center position of the second crankshaft 4d, and the center position of the B0-periphery 57 substantially coincides with the center position of the first crankshaft 4c. The center position of the A1-periphery 56 substantially coincides with the center position of the main shaft 4a, and the center position of the B1-periphery 58 substantially coincides with the center position of the countershaft 4b.

As the center positions of the main shaft 4a and countershaft 4b are the same, it can be said that the center position of the A1-periphery 56 substantially coincides with the center position of the counter shaft 4b, and the center position of the B1-periphery substantially coincides with the center position of the main shaft 4a.

The center position of the first inclined surface 60 substantially coincides with the center position of the first crankshaft 4c, and the center position of the second inclined surface 61 substantially coincides with the center position of the second crankshaft 4d.

Particularly, as shown in FIG. 12B, assuming the radius of the first roller 13a to be Ri, the inside radius of the end face of the first roller 13a provided with a bevel 20 at the inside edge to be Rt, and the minimum radius of the first inclined surface 60 to be Rk, the formula (10) is established.

Ri<Rk<Rt (10)

When the first roller 13a is inserted from the direction of the countershaft 4b of the rotary shaft 4, the end face and interior of the first roller 13a are not damaged. The counter parts, the first cylinder 8A and first crankshaft 4c or the main bearing 11 and intermediate partition board 7A, are prevented from damaging, and the reliability is improved.

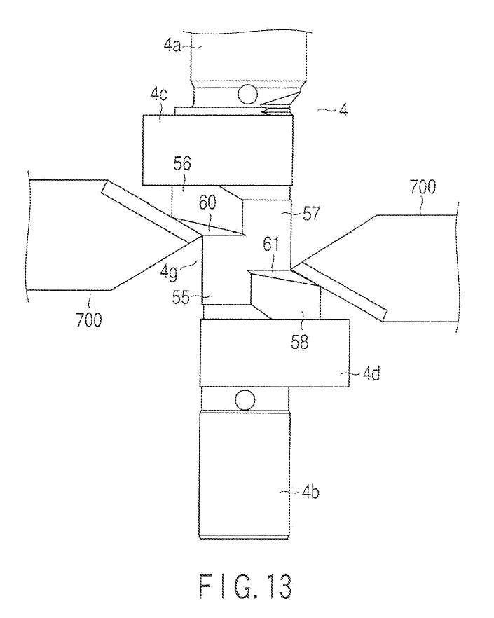

FIG. 13 shows the state of machining the first and second inclined surfaces 60 and 61, by using a cutting tool.

When cutting the first inclined surface 60, a cutting tool 700 is apart away from the first crankshaft 4c, and does not contact the first crankshaft 4c. Similarly, when cutting the second inclined surface 61, the cutting tool 700 is apart away from the second crankshaft 4d, and does not contact the second crankshaft 4d.

In other words, a part of the first inclined surface 60 extending to the outer periphery does not interfere with the first crankshaft 4c, and a part of the second inclined surface 61 extending to the outer periphery does not interfere with the second crankshaft 4d.

Therefore, when machining the first and second inclined surfaces 60 and 61, machining is possible by using the cutting tool 700 suitable for the inclination angle from the first machining step, without machining in several times by using cutting tools with different angles. As a result, the rotary shaft (crankshaft) 4, which does not interfere with the crankshafts 4c and 4d, can be easily manufactured at low cost.

By using the multi-cylinder rotary compressor 200, 210, 220 or 230 explained hereinbefore, it is possible to fit the first roller 13a to the first crankshaft 4c by inserting from direction of the countershaft 4b, and fit the second roller 13a to the second crankshaft 4d by inserting from the direction of the countershaft 4b, while ensuring the rigidity of the connecting parts 4e, 4f and 4g formed between the crankshafts 4c and 4d.

The rollers 13a and 13b can be smoothly fit with improved workability. In addition, the diameters of the crankshafts 4c and 4d can be reduced without reducing the diameter of the main shaft 4a. Therefore, the sliding loss of the crankshafts 4c and 4d, which occupies a large part of the sliding loss, can be reduced, noise and vibration can be reduced, and the reliability and compression performance can be improved.

By using the multi-cylinder rotary compressor 200, 210, 220 or 230 in refrigeration cycle equipment, the refrigeration cycle efficiency of the refrigeration cycle equipment can be improved.

The invention is not limited to the embodiments described hereinbefore. The invention may be embodied by modifying the constituent elements without departing from its spirit and essential characteristics in practical phases. The invention may be embodied in various specific forms by appropriately combining the constituent elements disclosed in the embodiments.

According to the invention, it is possible to provide a multi-cylinder rotary, in which a roller to be fitted to a crankshaft of a main shaft is inserted from the direction of the end face of a countershaft, sliding loss is reduced, dimensions are reduced, and compression performance and reliability are improved, and refrigeration cycle equipment which is improved in efficiency and reliability.

What is claimed is:

1. A multi-cylinder rotary compressor comprising:
a rotary shaft which comprises a main shaft pivotally fixed to a main bearing, a countershaft pivotally fixed to a sub-bearing, crankshafts provided eccentrically between the main shaft and countershaft, and fitted with rollers, and a connecting part connecting adjacent crankshafts; and
cylinder chambers which house the crankshafts and rollers of the rotary shaft in being eccentrically rotatable,
wherein formulas (1) and (2) are established, assuming the radius of the main shaft of the rotary shaft to be Rm, the radius of the countershaft to be Rs, the radius of the crankshaft to be Rc, and the eccentricity of the crankshaft to be e,
Rc<Rm+e (1)
Rc≧Rs+e (2)
the connecting part which connects a first crankshaft provided in the main shaft and a second crankshaft provided in the countershaft, comprises:
an A-periphery, which is positioned on the same level as the outer periphery of the second crankshaft, or inside the outer periphery, on the counter-eccentric side periphery of the second crankshaft 4d, and has a radius greater than the radius Rs of the countershaft; and
a B-periphery, which is positioned on the same level as the outer periphery of the first crankshaft, or inside the outer periphery, on the counter-eccentric side periphery of the first crankshaft, and has a radius greater than the radius Rs of the countershaft, and
a formula (3) is established, assuming the axial length of the connecting part to be L, the axial length of the roller fitted to the first crankshaft to be H, the axial length of a bevel formed at the inside peripheral edge of the roller fitted to the first crankshaft to be Cr, and the axial length of a bevel formed in the second crankshaft to be Cs,
L+Cs≧H−Cr
L≧H−Cr−Cs
H>L≧H−Cr−Cs (3)

2. The multi-cylinder rotary compressor according to claim 1, wherein the A periphery is formed on a peripheral surface, where the center positions of the A periphery substantially coincide with the center position of the second crankshaft, and
the B periphery is formed on a peripheral surface, where the center positions of the B periphery substantially coincide with the center position of the first crankshaft.

3. A multi-cylinder rotary compressor comprising:
a rotary shaft which comprises a main shaft pivotally fixed to a main bearing, a countershaft pivotally fixed to a sub-bearing, crankshafts provided eccentrically between the main shaft and countershaft, and fitted with rollers, and a connecting part connecting adjacent crankshafts; and
cylinder chambers which house the crankshafts and rollers of the rotary shaft in being eccentrically rotatable,
wherein formulas (4) and (5) are established, assuming the radius of the main shaft of the rotary shaft to be Rm, the radius of the countershaft to be Rs, the radius of the crankshaft to be Rc, and the eccentricity of the crankshaft to be e,
Rc<Rm+e (4)
Rc≧Rs+e (5)
the connecting part which connects a first crankshaft provided in the main shaft and a second crankshaft provided in the countershaft, comprises:
an A0-periphery, which is positioned on the same level as the outer periphery of the second crankshaft, or inside the outer periphery, on the counter-eccentric side periphery of the second crankshaft, and has a radius greater than the radius Rs of the countershaft, and an A1-periphery, which is positioned outside the counter-eccentric side periphery of the second crankshaft, between the A0-periphery and first crankshaft, and
a B0-periphery, which is positioned on the same level as the outer periphery of the first crankshaft, or inside the outer periphery, on the counter-eccentric side periphery of the first crankshaft, and has a radius greater than the radius Rs of the countershaft, and a B1-periphery, which is positioned outside the counter-eccentric side periphery of the first crankshaft, between the B0-periphery and second crankshaft, and
the outermost diameter So of the A1 and B1 peripheral surfaces is made smaller than the inside diameter Ri of the roller fitted to the first crankshaft,
the axial intermediate part of the connecting part is formed by the A0 and B0 peripheral surfaces, and
formulas (6) and (7) are established, assuming the axial length of the A0-periphery to be Ka, the axial length of the B0-periphery to be Kb, the axial length of the roller fitted to the first crankshaft to be H, the axial length of the bevel formed at the inside peripheral edge of a roller fitted to the first crankshaft to be Cr, and the axial length of the bevel formed in the second crankshaft to be Cs,
H>Ka≧H−Cr−Cs (6)
H>Kb≧H−Cr−Cs (7)

4. The multi-cylinder rotary compressor according to claim 3, wherein the A0 periphery is formed on a peripheral surface, where the center positions of the A0 periphery substantially coincide with the center position of the second crankshaft, and
the B0 periphery is formed on a peripheral surface, where the center positions of the B0 periphery substantially coincide with the center position of the first crankshaft.

5. The multi-cylinder rotary compressor according to claim 3, wherein the A1 and B1 peripheries are formed on a peripheral surface, which substantially coincides with the rotation centers of the main shaft and countershaft of the rotary shaft.

6. A multi-cylinder rotary compressor comprising:
a rotary shaft which comprises a main shaft pivotally fixed to a main bearing, a countershaft pivotally fixed to a sub-bearing, crankshafts provided eccentrically between the main shaft and countershaft, and fitted with rollers, and a connecting part connecting adjacent crankshafts; and
cylinder chambers which house the crankshafts and rollers of the rotary shaft in being eccentrically rotatable,
wherein formulas (8) and (9) are established, assuming the radius of the main shaft of the rotary shaft to be Rm, the radius of the countershaft to be Rs, the radius of the crankshaft to be Rc, and the eccentricity of the crankshaft to be e,
Rc<Rm+e (8)
Rc≧Rs+e (9)
the connecting part which connects a first crankshaft provided in the main shaft and a second crankshaft provided in the countershaft, comprises:
an A0-periphery, which is positioned on the same level as the outer periphery of the second crankshaft, or inside the outer periphery, on the counter-eccentric side periphery of the second crankshaft, and has a radius greater than the radius Rs of the countershaft, an A1-periphery, which is positioned outside the counter-eccentric side periphery of the second crankshaft, between the A-periphery and first crankshaft, and a first inclined surface formed in a step between the peripheral surfaces A0 and A1, and
a B-periphery, which is positioned on the same level as the outer periphery of the first crankshaft, or inside the outer periphery, on the counter-eccentric side periphery of the first crankshaft, and has a radius greater than the radius Rs of the countershaft, a B1-periphery, which is positioned outside the counter-eccentric side periphery of the first crankshaft, between the B0-periphery and second crankshaft, and a second inclined surface formed in a step between the B0 and B1 peripheries.

7. The multi-cylinder rotary compressor according to claim 6, wherein the center position of the first inclined surface substantially coincides with the center position of the second crankshaft, and
the center position of the second inclined surface substantially coincides with the center position of the first crankshaft.

8. The multi-cylinder rotary compressor according to claim 6, wherein a part of the first inclined surface extending to the outer periphery does not interfere with the first crankshaft, and
a part of the second inclined surface extending to the outer periphery does not interfere with the second crankshaft.

9. Refrigeration cycle equipment comprising the multi-cylinder rotary compressor according to claim 1, a condenser, an expansion device, and an evaporator.

10. Refrigeration cycle equipment comprising the multi-cylinder rotary compressor according to one of claim 3, a condenser, an expansion device, and an evaporator.

11. Refrigeration cycle equipment comprising the multi-cylinder rotary compressor according to claim 6, a condenser, an expansion device, and an evaporator.
